(19) United States
(12) Patent Application Publication
(10) Pub. No.: US 2015/0054741 A1
(43) Pub. Date: Feb. 26, 2015

(54) DISPLAY CONTROL DEVICE, DISPLAY CONTROL METHOD, AND PROGRAM

(71) Applicant: SONY CORPORATION, Tokyo (JP)

(72) Inventors: Ikuo YAMANO, Tokyo (JP); Kunihito SAWAI, Kanagawa (JP); Yuhei TAKI, Kanagawa (JP); Hiroyuki MIZUNUMA, Tokyo (JP); Yusuke NAKAGAWA, Tokyo (JP); Keisuke YAMAOKA, Tokyo (JP)

(21) Appl. No.: 14/333,916

(22) Filed: Jul. 17, 2014

(30) Foreign Application Priority Data
Aug. 21, 2013 (JP) 2013-171196

(51) Int. Cl. G06F 3/033

(52) U.S. Cl. CPC G06F 3/033
USPC 345/158

(57) ABSTRACT

There is provided a display control device including an acquisition unit configured to acquire contact information of contact of an operation body on an operation surface, a display control unit that has a first function of moving a cursor displayed on a display device in accordance with a change amount of a contact position indicated by the contact information acquired by the acquisition unit and a second function of displaying the cursor at a position, on a given display area of the display device, corresponding to the contact position, and a switch unit configured to switch a function to be exerted by the display control unit between the first function and the second function. The switch unit exerts the second function when the acquisition unit has acquired first contact information of contact of the operation body on a given operation area of the operation surface.

### CROSS REFERENCE TO RELATED APPLICATIONS

This application claims the benefit of Japanese Priority Patent Application JP 2013-171196 filed Aug. 21, 2013, the entire contents of which are incorporated herein by reference.

### BACKGROUND

The present disclosure relates to a display control device, a display control method, and a program.

Recently, in order to externally operate various information processing devices such as a television receiver and a personal computer (PC), an operation terminal having a remote controller function has been provided. As the function of an information processing device is diversified, it becomes general to perform various operations, using an operation terminal, on a screen. For such a use, it was difficult, with the existing operation terminal having buttons arranged thereon, to quickly operate a free pointing cursor on a screen as intended. Then, an operation terminal using a touch pad or a motion sensor, for example, is proposed.

There are two methods for controlling the movement of a cursor on a screen with the use of an operation terminal having a touch pad: a relative coordinate operation and an absolute coordinate operation. The relative coordinate operation is generally adopted in an operation terminal having a touch pad. Meanwhile, there is being developed a technology of improving operability by combining the relative coordinate operation and the absolute coordinate operation.

For example, JP 2001-117713A discloses the technology of an operation terminal capable of switching the relative coordinate operation and the absolute coordinate operation.

### SUMMARY

However, each of the relative coordinate operation and the absolute coordinate operation has advantages and disadvantages and, in the combination thereof and switching processing, it may be necessary to compensate the disadvantages while utilizing the advantages.

Thus, the present disclosure proposes a new and improved display control device, a display control method, and a program that are capable of further improving operability by effectively combining the relative coordinate operation and the absolute coordinate operation.

According to an embodiment of the present disclosure, there is provided a display control device including an acquisition unit configured to acquire contact information of contact of an operation body on an operation surface, a display control unit that has a first function of moving a cursor displayed on a display device in accordance with a change amount of a contact position indicated by the contact information acquired by the acquisition unit and a second function of displaying the cursor at a position, on a given display area of the display device, corresponding to the contact position, and a switch unit configured to switch a function to be exerted by the display control unit between the first function and the second function. The switch unit exerts the second function when the acquisition unit has acquired first contact information of contact of the operation body on a given operation area of the operation surface.

According to an embodiment of the present disclosure, there is provided a display control method including acquiring contact information of contact of an operation body on an operation surface, switching a function to be exerted between a first function of moving a cursor displayed on a display device in accordance with a change amount of a contact position indicated by the acquired contact information and a second function of displaying the cursor at a position, on a given display area of the display device, corresponding to the contact position, and exerting the second function when first contact information of contact of the operation body on a given operation area of the operation surface has been acquired.

According to an embodiment of the present disclosure, there is provided a program causing a computer to execute acquiring contact information of contact of an operation body on an operation surface, switching a function to be exerted between a first function of moving a cursor displayed on a display device in accordance with a change amount of a contact position indicated by the acquired contact information and a second function of displaying the cursor at a position, on a given display area of the display device, corresponding to the contact position, and exerting the second function when first contact information of contact of the operation body on a given operation area of the operation surface has been acquired.

According to one or more of embodiments of the present disclosure, it is possible to further improve operability by effectively combining the relative coordinate operation and the absolute coordinate operation.

### BRIEF DESCRIPTION OF THE DRAWINGS

FIG. 1 is an explanatory diagram illustrating a relative coordinate operation in a display control system according to an embodiment of the present disclosure;

FIG. 2 is a diagram for explaining an absolute coordinate operation in the display control system according to an embodiment of the present disclosure;

FIG. 3 is an explanatory diagram illustrating display control processing in the display control system according to an embodiment of the present disclosure;

FIG. 4 is an explanatory diagram illustrating display control processing in a display control system according to a comparative example;

FIG. 5 is an explanatory diagram illustrating an appearance configuration of an operation terminal according to a first embodiment;

FIG. 6 is a schematic view illustrating a pressing configuration of a touch pad according to the first embodiment;

FIG. 7 is a block diagram illustrating an internal configuration of the operation terminal according to the first embodiment;

FIG. 8 is an explanatory diagram illustrating an operation in an absolute coordinate mode according to the first embodiment;

FIG. 9 is an explanatory diagram illustrating an operation in a relative coordinate mode according to the first embodiment;

FIG. 10 is a flowchart illustrating operations of a display control system according to the first embodiment.

FIG. 11 is a flowchart illustrating switching processing by a switch unit according to the first embodiment.

FIG. 12 is a flowchart illustrating switching processing by the switch unit according to the first embodiment.

FIG. 13 is a diagram for explaining a display control system according to a modification.

FIG. 14 is an explanatory diagram illustrating an overview of a display control system according to a second embodiment;

FIG. 15 is a side view illustrating an appearance configuration of a touch pad according to the second embodiment;

FIG. 16 is a block diagram illustrating an internal configuration of an operation terminal according to the second embodiment; and

FIG. 17 is a flowchart illustrating operations of the display control system according to the second embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that description will be provided in the following order.

1. Overview of display control processing according to an embodiment of present disclosure

### 2. Embodiments

2-1. First embodiment

### 2-1-1. Configuration

2-1-2. Operation processing

### 2-1-3. Modification

2-2. Second embodiment

### 2-2-1. Overview

### 2-2-2. Configuration

2-2-3. Operation processing

### 3. Conclusion

### OVERVIEW OF DISPLAY CONTROL PROCESSING ACCORDING TO AN EMBODIMENT OF PRESENT DISCLOSURE

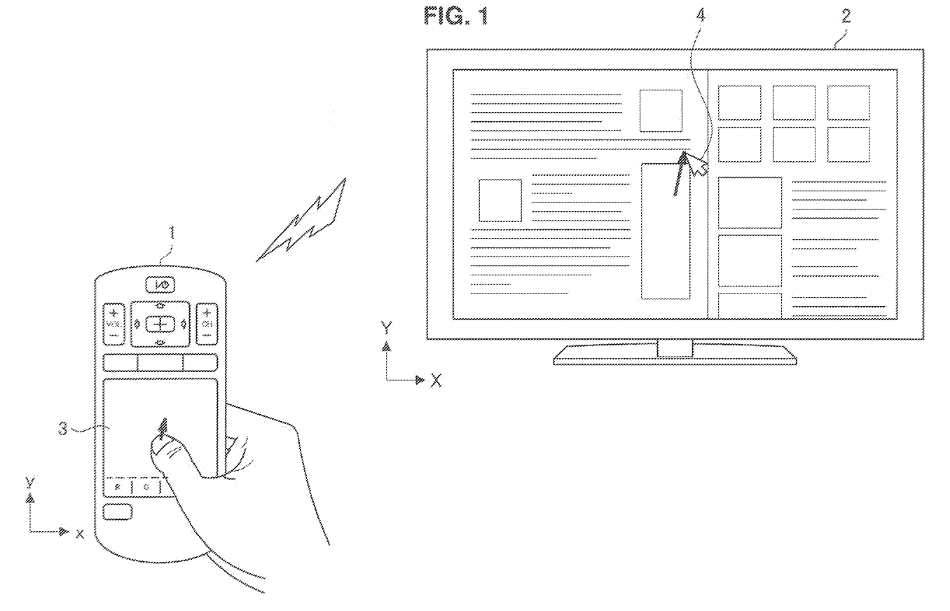

First, the overview of display control processing according to an embodiment of the present disclosure will be described with reference to FIG. 1 to FIG. 4.

FIG. 1 is an explanatory diagram illustrating a relative coordinate operation in a display control system according to an embodiment of the present disclosure. As illustrated in FIG. 1, the display control system according to an embodiment of the present disclosure includes an operation terminal 1 and a display device 2, and performs display control processing.

The operation terminal 1 is a terminal operated by a user, and detects contact between a touch pad 3 (an operation surface) and an operation body such as a user's finger and a stylus. Then, the operation terminal 1 generates, based on the detection result, control signals for operating a cursor 4 and transmits the control signals to the display device 2. The display device 2 displays, deletes, or moves the cursor 4 based on the control signals received from the operation terminal 1.

Here, the display control system of the embodiment controls the movement of the cursor 4 in one of operation modes of a relative coordinate mode (a first function) allowing a relative coordinate operation and an absolute coordinate mode (a second function) allowing an absolute coordinate operation. In the following, the relative coordinate operation in the display control system of the embodiment will be described first with reference to FIG. 1.

As illustrated in FIG. 1, in the relative coordinate operation, when a user moves his/her finger while keeping it touched on the touch pad 3, the cursor 4 is moved in accordance with a movement distance and a movement direction of the touch point. The relative coordinate operation is an operation method generally adopted in a notebook PC, for example. In the relative coordinate operation, the cursor 4 is displayed regardless of whether the touch pad 3 is touched. When the touch pad 3 is touched, the cursor 4 is moved on the screen by an amount in accordance with a movement distance and a movement direction of the touch point after being touched.

The relative coordinate operation has the following merits: “the cursor 4 does not disappear although a user releases his/her finger from the touch pad 3”, “a user does not feel discomfort because the operation is similar to that of a notebook PC, for example”, and “it is easy to adjust the cursor 4 onto a small object on a screen”. However, the relative coordinate operation has the following problems: “when a movement amount of the cursor 4 is large, repeated sliding of a finger is necessary” and “an intuitive operation is difficult to perform”.

The relative coordinate operation often employs “cursor acceleration and deceleration processing” in which a movement amount of a cursor is increased when an input movement amount on a touch pad per unit time is large, while a movement amount of a cursor is reduced when an input movement amount is small. Such processing enables a user to point out an object by a cursor relatively easily even when the object to be selected by the cursor is small.

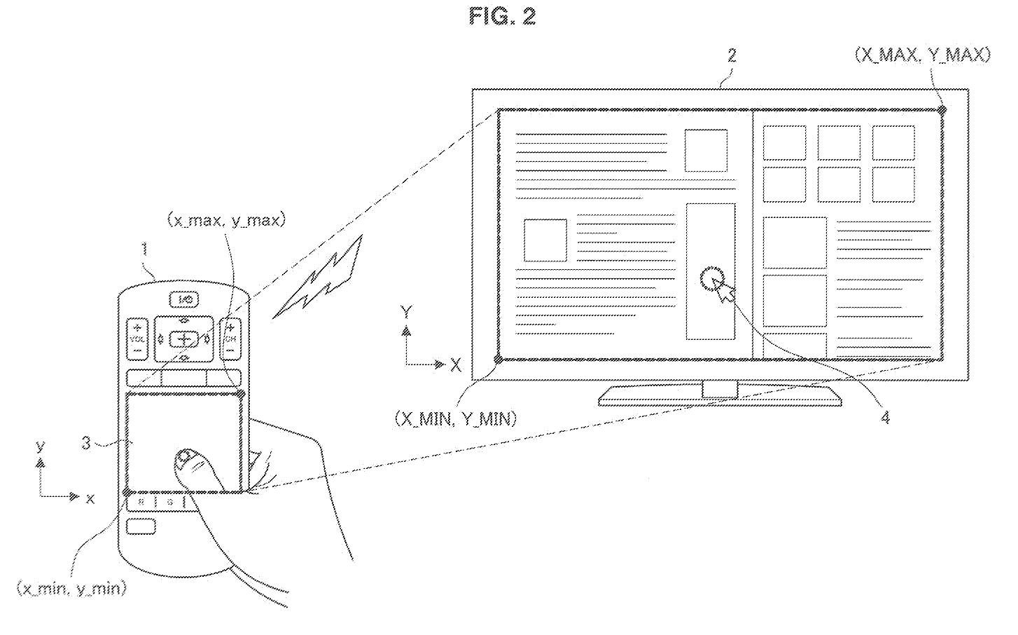

The relative coordinate operation in the display control system of the embodiment has been described. Subsequently, the absolute coordinate operation in the display control system of the embodiment will be described with reference to FIG. 2.

FIG. 2 is a diagram for explaining the absolute coordinate operation in the display control system according to an embodiment of the present disclosure. As illustrated in FIG. 2, in the absolute coordinate operation, when a user touches the touch pad 3 with his/her finger, the cursor 4 is displayed at a position corresponding to coordinates of the touch point (touch coordinates). For example, when the user touches “x_min”, “y_min” on the touch pad 3, the cursor 4 is displayed at “X_MIN”, “Y_MIN”. When the user touches “x_max”, “y_max”, the cursor 4 is displayed at “X_MAX”, “Y_MAX”. That is, the absolute coordinate operation is an operation method for associating touch coordinates on the touch pad 3 and a cursor position on a screen in one-to-one relation. In the absolute coordinate operation, the cursor 4 is not displayed unless the touch pad 3 is touched.

The absolute coordinate operation has a merit of enabling the user to specify a position of the cursor 4 intuitively, in the manner of “touching the upper part of the touch pad 3 to point out the upper side of the screen”, for example. Moreover, the user can quickly move the cursor 4 to a corner portion of the screen such as a lower right portion of the screen, for example, by moving his/her finger using the texture (tactile sense, for example) of the edge portion around the touch pad 3 as a clue. Such a merit reduces a pointing burden of a user and improves an operation speed. However, the absolute coordinate operation has the following problems: “the cursor 4 disappears once a user releases his/her finger from the touch pad 3”, and “a user who is familiar with the relative coordinate operation in a notebook PC, for example, feels discomfort in the absolute coordinate operation”. The absolute coordinate operation also has a problem of “difficulty of adjustment of the cursor 4 onto a small object on the screen” because a large screen and the small touch pad 3 are associated in one-to-one relation.

The absolute coordinate operation in the display control system of the embodiment has been described.

As described above, each of the relative coordinate operation and the absolute coordinate operation has advantages and disadvantages. The relative coordinate operation has been generally adopted in an operation terminal having a touch pad, and the merit of the absolute coordinate operation has not been utilized. However, when the merits of the absolute coordinate operation are utilized as well as the merits of the relative coordinate operation, the operability of the operation terminal is further improved.

In view of the above aspects, there has been made the operation terminal 1 (a display control device) according to each embodiment of the present disclosure. The operation terminal 1 according to each embodiment of the present disclosure can further improve operability by effectively combining the relative coordinate operation and the absolute coordinate operation.

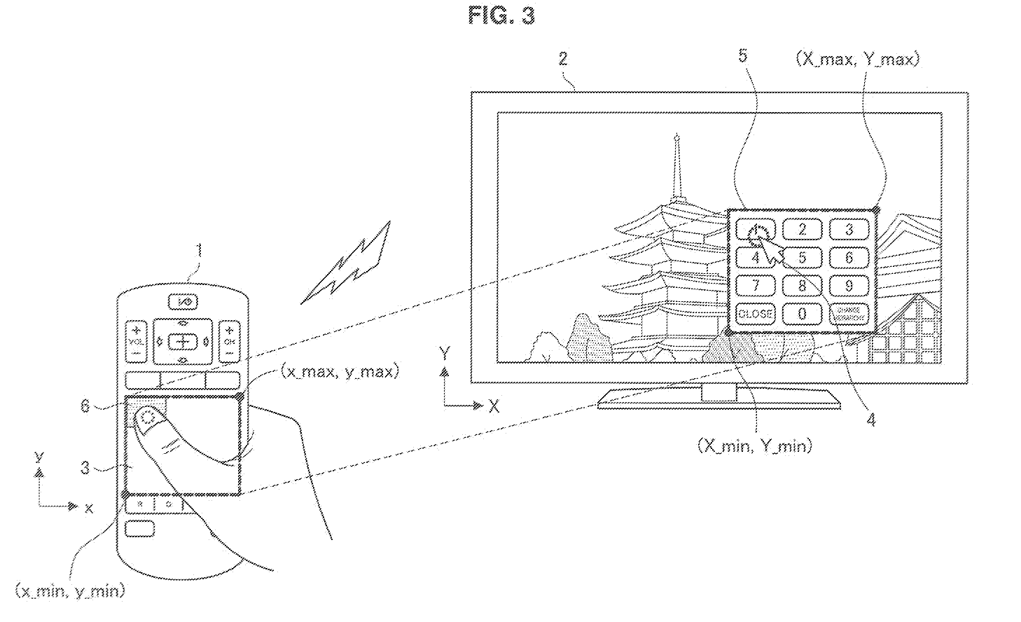

To be more specific, the operation terminal 1 includes a hit area 6 on the touch pad 3, as illustrated in FIG. 3. FIG. 3 is an explanatory diagram illustrating display control processing in the display control system according to an embodiment of the present disclosure. When a given operation is performed on the hit area 6, the operation terminal 1 displays an on-screen key 5 and the cursor 4 on the display device 2, and starts an operation in the absolute coordinate mode. Then, the operation terminal 1 continues the operation in the absolute coordinate mode until a finger is released from the touch pad 3.

The on-screen key 5 is an operation area (a given display area) displayed on a part of the screen, and includes numeral keys of 0 to 9 as illustrated in FIG. 3, for example. The on-screen key 5 is displayed on the screen instead of the numeral keys arranged on the operation terminal 1, so as to simplify the configuration of the operation terminal 1. A user can input a number or change a television channel, for example, by operating the cursor 4 to select and confirm a numeral key on the screen. Note that the keys of the on-screen key 5 are not limited to numeral keys, and may be playback/stop keys, fast forward/rewinding keys, confirmation key, or volume adjustment keys, for example.

In the absolute coordinate mode, the movement range of the cursor 4 is within the on-screen key 5, and the cursor 4 is operated by a user by the absolute coordinate operation. For example, when the user touches “x_min”, “y_min” on the touch pad 3, the cursor 4 is displayed at “X_min”, “Y_min” on the on-screen key 5. When the user touches “x_max”, “y_max” on the touch pad 3, the cursor 4 is displayed at “X_max”, “Y_max” on the on-screen key 5. That is, in the absolute coordinate mode, touch coordinates on the touch pad 3 and a cursor position on the on-screen key 5 are associated in one-to-one relation.

Thus, the user can perform an intuitive and quick operation in the absolute coordinate mode, as described above. Furthermore, the on-screen key 5 that is a partial area of the screen and thus smaller than the entire screen is associated with the touch pad 3 in one-to-one relation, which reduces the above-described problem of “difficulty of adjustment of the cursor 4 onto a small object on the screen” in the absolute coordinate operation. In this manner, the operation terminal 1 of the embodiment can reduce such a problem while utilizing the merits of the absolute coordinate operation. In the following, the operation terminal 1 of the embodiment, a comparative example, and the technology described in JP 2001-117713A will be compared with one another.

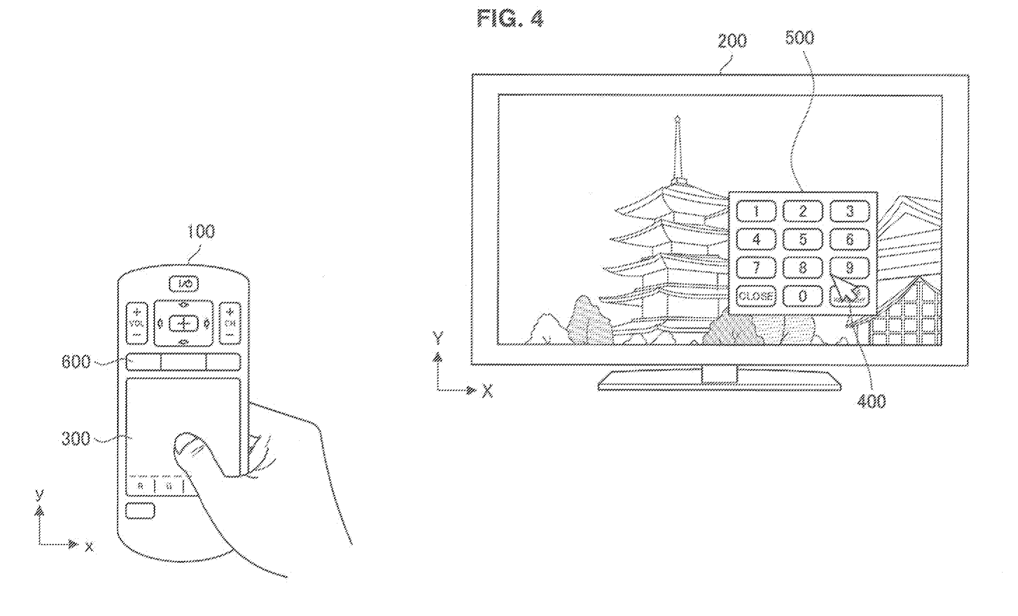

FIG. 4 is an explanatory diagram illustrating display control processing in a display control system according to the comparative example. An operation terminal 100 of the comparative example includes a physical key 600 separately from a touch pad 300. When the physical key 600 is pressed, the operation terminal 100 displays an on-screen key 500 as well as a cursor 400 on a screen of a display device 200. Then, the operation terminal 100 operates the displayed cursor 400 by the relative coordinate operation. The operation terminal 100 displays the cursor 400 at a center, for example, in the range of the on-screen key 500, thereby reducing a burden of a user in selecting a numeral key. However, the user may not enjoy the merit of the absolute coordinate operation such as capability of performing an intuitive and quick operation that can be enjoyed in the operation terminal 1 of the embodiment.

Moreover, the above-described JP 2001-117713A discloses the technology of switching an operation from the relative coordinate operation, which is performed in the normal state, to the absolute coordinate operation when the cursor enters a partial area on the screen. However, the user is forced to perform the relative coordinate operation until the cursor 4 enters the partial area, and may not immediately enjoy the merit of the absolute coordinate operation. By contrast, in the embodiment, the user can immediately start an operation on the on-screen key 5 by pressing the hit area 6, and can enjoy the merit of the absolute coordinate operation immediately.

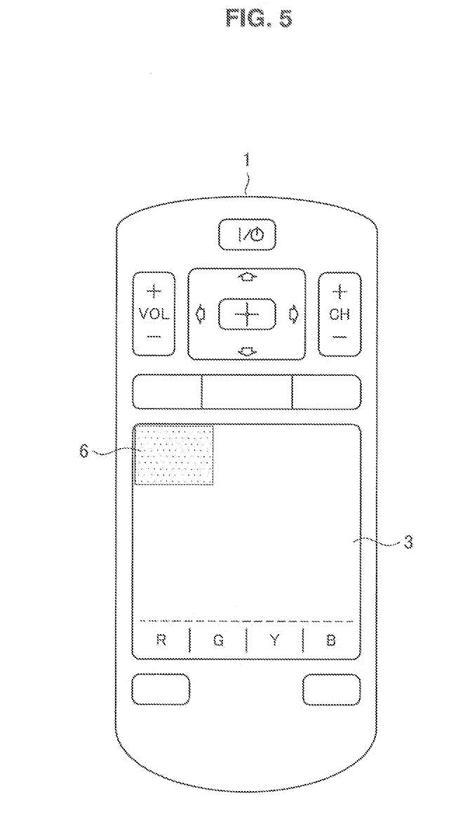

The overview of the display control method of the embodiment has been described. Subsequently, each embodiment will be described in detail with reference to FIG. 5 to FIG. 17.

### 2. EMBODIMENTS

### 2-1. First Embodiment

First, a configuration of the display control system according to the embodiment will be described with reference to FIG. 5 to FIG. 9.

### [2-1-1. Configuration]

FIG. 5 is an explanatory diagram illustrating an appearance configuration of the operation terminal 1 according to the first embodiment. As illustrated in FIG. 5, the operation terminal 1 includes the touch pad 3.

The touch pad 3 is a flat plate sensor, and is an input device that detects contact with an operation body such as a user's finger and a stylus. The touch pad 3 includes an electrostatic capacitance type touch sensor, for example, and detects a form of touch points and coordinates of each touch point based on a change of electrostatic capacity of a plurality of electrodes. The electrostatic capacitance type touch sensor has a problem of a phenomenon (a ghost phenomenon) in which the change of electrostatic capacity is detected even in an area with which an object to be detected is not actually in contact.

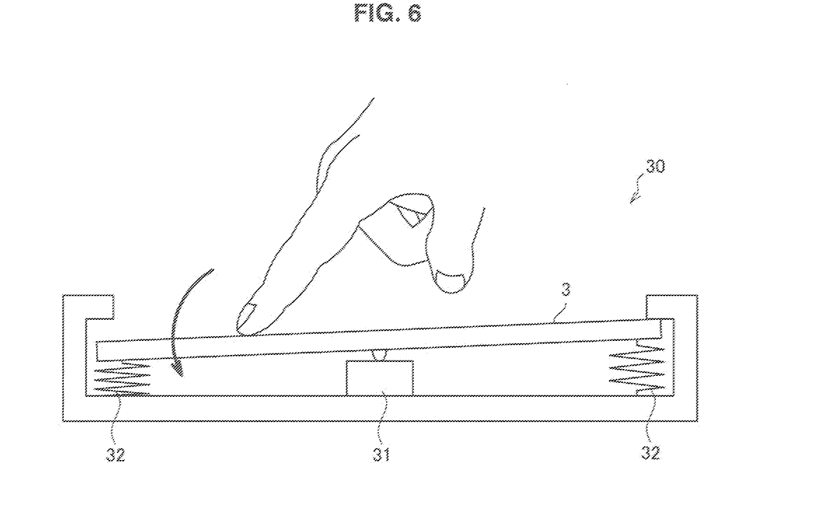

The hit area 6 (a given operation area) is formed on a partial area of the touch pad 3. The hit area 6 is an area distinguished by color from other areas so that the user can easily grasp the area visually. When the hit area 6 is pressed and a switch provided on the back side of the touch pad 3 is pressed, the operation terminal 1 starts an operation in the absolute coordinate mode. In the following, the pressing configuration of the touch pad 3 will be described with reference to FIG. 6.

FIG. 6 is a schematic view illustrating a pressing configuration of the touch pad 3 according to the first embodiment. As illustrated in FIG. 6, a pressing configuration 30 includes the touch pad 3, compression springs 32, and a switch 31. As illustrated in FIG. 6, the switch 31 is arranged under the touch pad 3, and the compression springs 32 are arranged on both sides of the switch 31. When the touch pad 3 is pressed by a finger, the switch 31 detects the pressing operation. Thereafter, the touch pad 3 returns to an original position by reaction force.

In the present description, the explanation will be given assuming that the operation terminal 1 starts an operation in the absolute coordinate mode by the pressing operation described above. However, the present technology is not limited to such an example. For example, the operation terminal 1 may start an operation in the absolute coordinate mode by touching or tapping on the hit area 6, or pressing of a physical key provided separately from the touch pad 3, for example.

Moreover, the operation terminal 1 of the embodiment adopts the above-described pressing operation as a method for performing a confirmation operation after moving the cursor 4. This is because the pressing operation enables a confirmation operation without releasing a finger from the touch pad 3, which is useful particularly when the confirmation operation is performed while keeping the absolute coordinate mode. In addition, the operation terminal 1 may receive the confirmation operation using the cursor 4 by touching or tapping, or pressing of a physical key, for example.

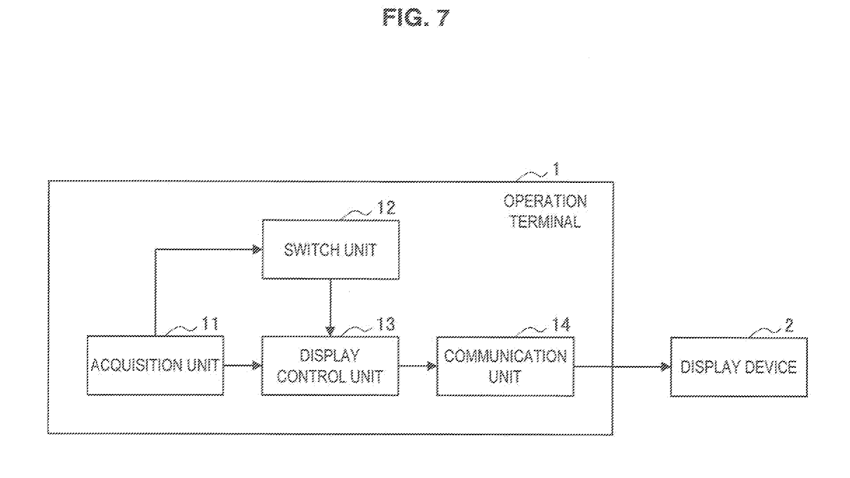

The appearance configuration of the operation terminal 1 and the pressing configuration of the touch pad 3 have been described. Next, the internal configuration of the operation terminal 1 will be described with reference to FIG. 7.

FIG. 7 is a block diagram illustrating an internal configuration of the operation terminal 1 according to the first embodiment. As illustrated in FIG. 7, the operation terminal 1 includes an acquisition unit 11, a switch unit 12, a display control unit 13, and a communication unit 14. The operation terminal 1 is a terminal operated by a user, and controls display of the display device 2 based on a user operation. The operation terminal 1 is achieved by a dedicated information processing device, a smartphone, a tablet terminal, a mobile phone terminal, a portable music playback device, a portable video processing device, or a portable game device, for example.

(Acquisition Unit 11)

The acquisition unit 11 has a function of acquiring contact information indicating contact between the touch pad 3 and an operation body such as a user's finger and a stylus. The acquisition unit 11 acquires, from the touch pad 3, information indicating a contact position (touch coordinates) of the operation body on the touch pad 3 and information indicating contact time, a contact pressure, or an operation kind such as touching and tapping. The acquisition unit 11 also acquires, from the switch 31, information indicating the presence or absence of a pressing operation. In the following, the explanation will be given assuming that the operation body is a finger. The acquisition unit 11 outputs such acquired information to the switch unit 12 and the display control unit 13.

(Switch Unit 12)

The switch unit 12 has a function of switching the operation mode to be used by the display control unit 13 in display control of the cursor 4 between the absolute coordinate mode and the relative coordinate mode. Concretely, the switch unit 11 switches the operation mode of the display control unit 13 based on contact information acquired by the acquisition unit 11. Note that the switch unit 12 may stop display control of the display device 2 by the display control unit 13 so that the cursor 4 and the on-screen key 5 are not displayed.

When the acquisition unit 11 acquires contact information indicating that the hit area 6 has been pressed while the cursor 4 and the on-screen key 5 are not displayed on the display device 2, the switch unit 12 switches the operation mode of the display control unit 13 to the absolute coordinate mode. Then, the switch unit 12 keeps the operation mode in the absolute coordinate mode until the acquisition unit 11 acquires contact information indicating that the finger of the user has been released from the touch pad 3. Note that hereinafter, the release of user's finger from the touch pad 3 will be also referred to as touch release.

When the acquisition unit 11 acquires contact information indicating that touch release has been performed after the operation mode of the display control unit 13 is switched to the absolute coordinate mode, the switch unit 12 switches the operation mode of the display control unit 13 to the relative coordinate mode. In this manner, the user can operate the cursor 4 by the absolute coordinate operation after the pressing operation is performed until the finger is released from the touch pad 3 and by the relative coordinate operation after the finger is released. There is no need to press another physical key for switching the operation mode, which improves the convenience of the user.

The absolute coordinate mode is kept until the finger is released. Thus, the user originally intending the absolute coordinate operation can complete the operation without recognizing switching to the relative coordinate operation. By contrast, the operation mode is switched to the relative coordinate mode at timing when the finger is released. Thus, the user originally intending the relative coordinate operation can complete the operation without recognizing the interposed absolute coordinate operation. In this manner, the operation terminal 1 of the embodiment can provide any users with an intuitive operation.

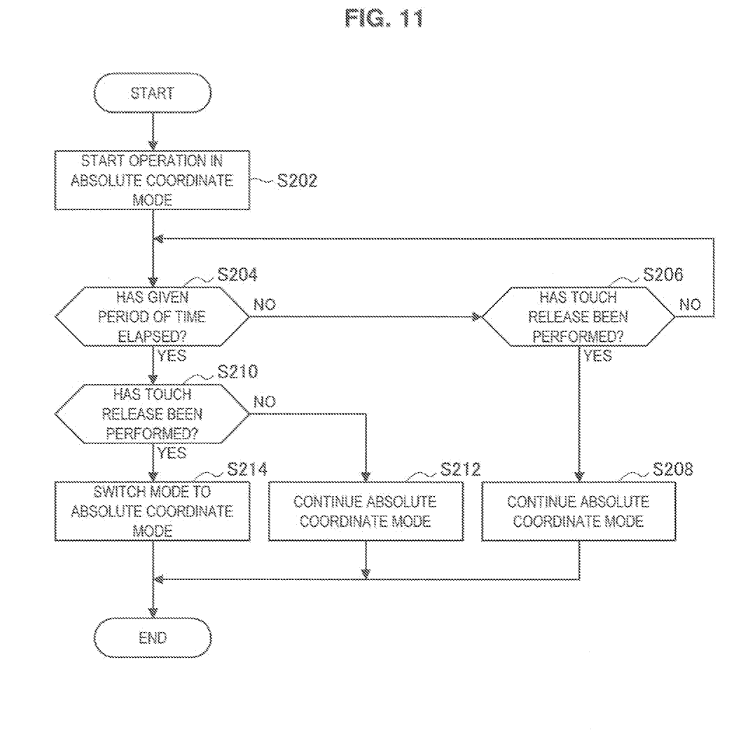

The switch unit 12 switches the operation mode based on timing at which a finger is released from the touch pad 3. To be more specific, the switch unit 12 determines whether the operation mode is to be switched to the relative coordinate mode when touch release is performed, based on whether a given period of time (first time) has elapsed after the operation mode is switched to the absolute coordinate mode. The switch unit 12 keeps the operation in the absolute coordinate mode when touch release is performed before the given period of time has elapsed. Thus, even when the user releases his/her finger by mistake immediately after the pressing operation, the user can perform the absolute coordinate operation by touching the touch pad 3 again. By contrast, when touch release is performed after the given period of time has elapsed, the switch unit 12 switches the operation mode to the relative coordinate mode. Thus, the user can perform an operation of roughly positioning the cursor 4 by the absolute coordinate operation and then finely adjusting the cursor 4 onto a small object on the screen by the relative coordinate operation. Such switching processing by the switch unit 12 will be described later in detail with reference to FIG. 11.

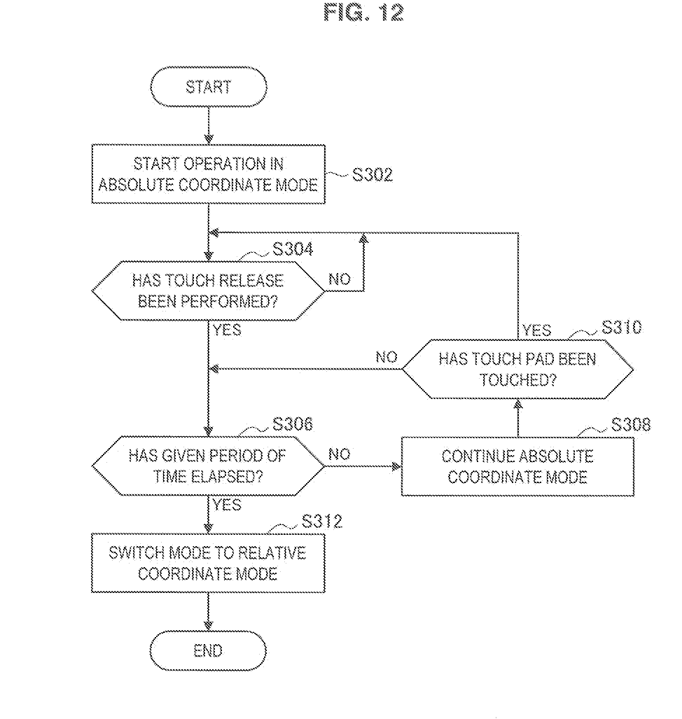

Moreover, the switch unit 12 switches the operation mode based on time during which a finger is separate from the touch pad 3. To be more specific, when the acquisition unit 11 acquires contact information indicating that a finger is separate from the touch pad 3 during a given period of time (second time) after the operation mode is switched to the absolute coordinate mode, the switch unit 12 switches the operation mode to the relative coordinate mode. Thus, even when the user releases his/her finger by mistake, the user can keep the absolute coordinate operation by touching the touch pad 3 again immediately. By contrast, when the user intentionally keeps his/her finger separate from the touch pad 3 during a given period of time or longer, he/she can perform the subsequent operation by the relative coordinate operation. Such switching processing by the switch unit 12 will be described later in detail with reference to FIG. 12.

(Display Control Unit 13)

The display control unit 13 has a function of performing display control of the cursor 4 in one of the relative coordinate mode and the absolute coordinate mode based on contact information acquired by the acquisition unit 11. In the absolute coordinate mode, the display control unit 13 displays the cursor 4 at a position, on the screen of the display device 2, corresponding to touch coordinates on the touch pad 3. By contrast, in the relative coordinate mode, the display control unit 13 moves the cursor 4 displayed on the display device 2 in accordance with a change amount of touch coordinates. The display control unit 13 operates in one of the operation modes in accordance with switching by the switch unit 12.

When the switch unit 12 switches the operation mode to the absolute coordinate mode while the on-screen key 5 is not displayed on the display device 2, the display control unit 13 displays an image indicating the on-screen key 5 on the display device 2. Then, the display control unit 13 displays the cursor 4 at a position, on the on-screen key 5, corresponding to touch coordinates on the touch pad 3, as illustrated in FIG. 3. Here, the position at which the cursor 4 appears is varied depending on touch coordinates on the hit area 6, as illustrated in FIG. 3. In this manner, the display control unit 13 displays the on-screen key 5 and starts the operation in the absolute coordinate mode.

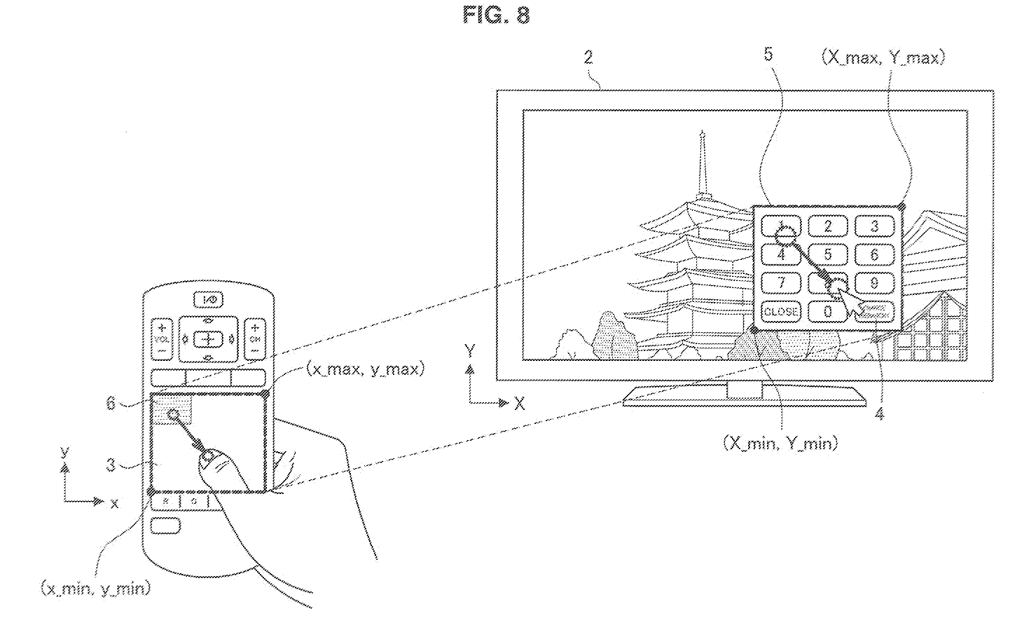

Then, the display control unit 13 performs display so that the touch coordinates and the cursor position on the screen are associated in one-to-one relation, as illustrated in FIG. 8, until the switch unit 12 switches the operation mode to the relative coordinate mode, that is, until the user releases his/her finger from the touch pad 3. FIG. 8 is an explanatory diagram illustrating an operation in the absolute coordinate mode according to the first embodiment.

As illustrated in FIG. 8, the user presses the hit area 6 and then slides his/her finger for an operation without releasing it from the touch pad 3, thereby performing an operation by the absolute coordinate operation. Here, the user can perform an intuitive operation with the texture of the edge portion around the touch pad 3 as a clue. For example, the user can perform an intuitive operation using the tactile sense of the edge portion, such as touching of an upper right corner of the touch pad 3 for selecting “3” and touching of a center portion of a lower side edge of the touch pad 3 for selecting “0”.

Regarding numeral keys, in particular, the merit of the intuitive operation by the absolute coordinate operation is further utilized because there frequently occurs the case in which a plurality of numbers are input consecutively, such as in the operation for selecting a channel of three digits. Here, the above-described cursor acceleration and deceleration processing is not applied to the absolute coordinate mode, which makes it difficult to adjust the cursor 4 onto a small object on the screen such as the numeral keys illustrated in FIG. 8. However, the range in which the cursor 4 is moved is not the entire area but a limited area of the screen, whereby the area of the touch pad corresponding to one button is larger, and the problem is reduced.

In this manner, the operation terminal 1 of the embodiment can utilize the merit of the absolute coordinate operation. Subsequently, an operation performed when the absolute coordinate mode has been switched to the relative coordinate mode will be described.

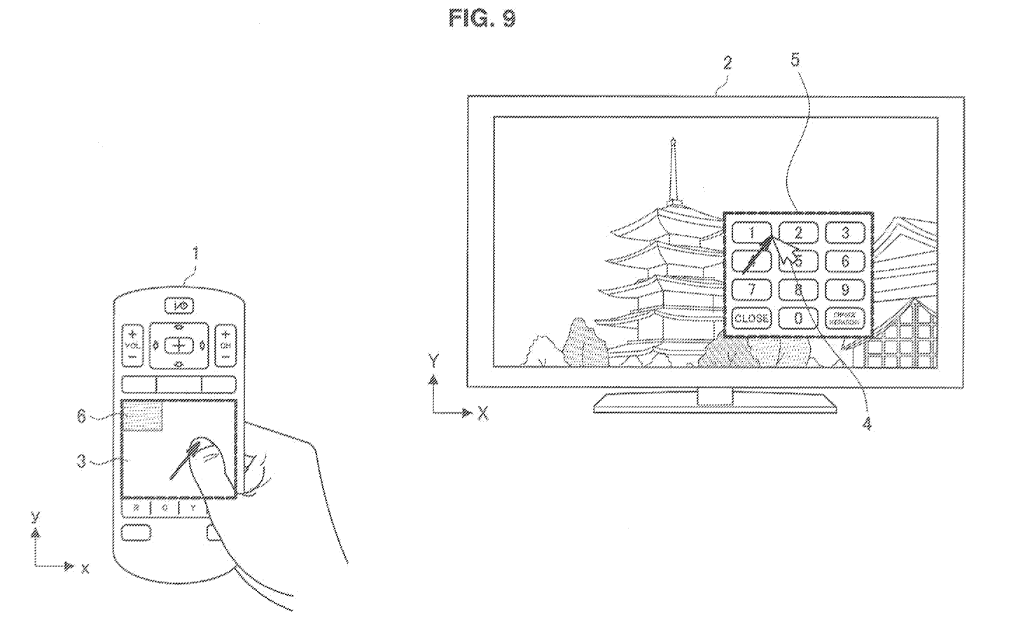

Once the switch unit 12 switches the absolute coordinate mode to the relative coordinate mode while the cursor 4 and the on-screen key 5 are displayed on the display device 2, the display control unit 13 starts an operation in the relative coordinate mode. Thus, once the user presses the hit area 6 and then releases his/her finger from the touch pad 3, he/she operates the cursor 4 in the relative coordinate mode, as illustrated in FIG. 9. FIG. 9 is an explanatory diagram illustrating an operation in the relative coordinate mode according to the first embodiment.

The switch unit 12 switches the operation mode to the relative coordinate mode when a finger is released from the touch pad 3, and thus the display control unit 13 can continue to display the cursor 4. Therefore, the problem of “disappearance of the cursor 4 once a user releases his/her finger from the touch pad 3” is resolved. Once the finger is released, the user may not perform an operation using the tactile sense by the texture of the edge portion around the touch pad 3. However, the user can perform an operation with the sense of the relative coordinate operation with which he/she is familiar in the operation of a notebook PC, for example.

Here, the display control unit 13 may limit the movement range of the cursor 4 within the range of the on-screen key 5. This prevents the case in which the cursor 4 is deviated from the on-screen key 5 against user's intention, thus improving operability.

Moreover, after the absolute coordinate mode is switched to the relative coordinate mode, the display control unit 13 may substantially match a movement amount (a gain) of the cursor corresponding to a change amount of touch coordinates with a movement amount (a gain) corresponding to a change amount of touch coordinates in the absolute coordinate mode. Thus, when the relative coordinate operation is performed after the absolute coordinate operation, the gains of the cursor movements substantially match each other, which prevents the user from feeling discomfort caused by a change of a manner of movement of the cursor during an operation. In addition, the display control unit 13 may further improve easiness of pointing by the above-described cursor acceleration and deceleration processing. The display control unit 13 may selectively perform gain substantially-matching processing or acceleration and deceleration processing in cursor movement depending on a use condition of the user or a screen displayed on the display device 2, or may perform both of processing.

Note that the display control unit 13 may perform an operation in the relative coordinate mode even when the on-screen key 5 is not displayed on the display device 2. Thus, the user can perform a cursor operation on an Internet browser, for example, other than the on-screen key 5, by the relative coordinate operation.

In this manner, the operation terminal 1 of the embodiment is a hybrid operation terminal that provides a user with an intuitive operation by the absolute coordinate operation and also enables, by employing also the relative coordinate operation, an operation without causing the user to feel discomfort of a special operation. When the user intends the absolute coordinate operation, he/she presses the hit area 6 and then performs an operation without releasing his/her finger from the touch pad 3, thus enjoying the merit of the absolute coordinate operation. By contrast, when the user intends the relative coordinate operation, he/she releases his/her finger from the touch pad 3 once, thus enjoying the merit of the relative coordinate operation. This allows the user to perform an operation without especially recognizing the absolute coordinate operation.

The display control unit 13 may delete display of the on-screen key 5 and the cursor 4 when a given condition is fulfilled. For example, the display control unit 13 may delete the display when a given period of time has elapsed while a finger is separate from the touch pad 3, and may continue the display when the touch pad 3 is touched again with a finger before the given period of time has elapsed. The display control unit 13 may delete the display once a confirmation button (Return key) (not illustrated) is pressed.

The display control unit 13 generates display control signals for controlling display of the display device 2 such as movement control of the cursor 4 and display control of the on-screen key 5, as described above, and outputs the display control signals to the communication unit 14.

(Communication Unit 14)

The communication unit 14 is a communication module for transmitting and receiving data to and from external devices. The communication unit 14 performs wireless communication with external devices directly or through a network access point in the system of wireless local area network (LAN), wireless fidelity (Wi-Fi (registered trademark)), infrared communication, or Bluetooth (registered trademark), for example. The communication unit 14 of the embodiment transmits display control signals output from the display control unit 13 to the display device 2.

(Display Device 2)

The display device 2 is a device that performs image display based on display control signals received from the operation terminal 1. The display device 2 is achieved by a television receiver, a display, a notebook PC, a smartphone, a tablet terminal, a mobile phone terminal, a portable video processing device, or a portable game device, for example.

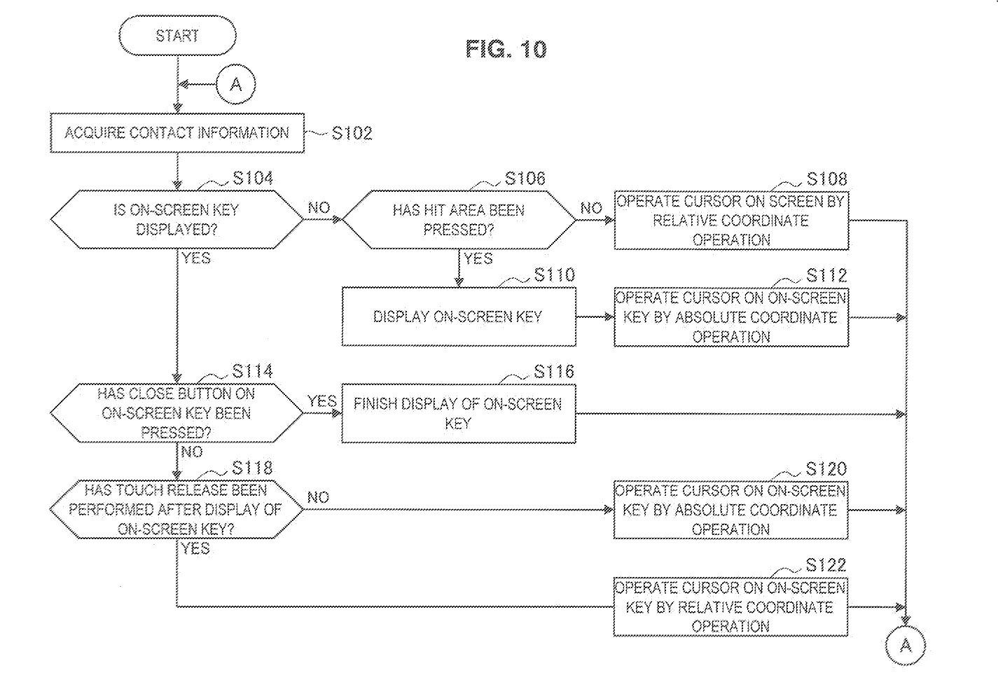

The configuration of the display control system according to the embodiment has been described. Next, the operation processing of the display control system according to the embodiment will be described with reference to FIG. 10 to FIG. 12.

### [2-1-2. Operation Processing]

First, the entire operation processing of the display control system of the embodiment will be described with reference to FIG. 10.

(Entire Operation)

FIG. 10 is a flowchart illustrating operations of the display control system according to the first embodiment. As illustrated in FIG. 10, the acquisition unit 11 first acquires contact information of contact of a finger on the touch pad 3 (Step S102). To be more specific, the acquisition unit 11 acquires, from the touch pad 3, information indicating coordinates of a touch point, contact time, or an operation kind such as touching and tapping. The acquisition unit 11 also acquires, from the switch 31, information indicating the presence or absence of a pressing operation.

Next, the display control unit 13 determines whether the on-screen key 5 is displayed on the display device 2 (Step S104). For example, the display control unit 13 determines it based on history information of whether the on-screen key 5 has been displayed or whether the display of the on-screen key 5 has been then switched into a non-display state, by past user operations, for example. In addition, the display control unit 13 may determine it by inquiring of the display device 2 through the communication unit 14.

When the on-screen key 5 is not displayed (No at S104), the switch unit 12 determines whether the hit area 6 has been pressed (Step S106). To be more specific, the switch unit 12 determines whether the acquisition unit 11 has acquired contact information indicating that the hit area 6 is pressed.

When the hit area 6 has not been pressed (No at S106), the display control unit 13 performs movement control of the cursor 4 on the display by the relative coordinate operation (Step S108). To be more specific, the display control unit 13 performs the operation in the relative coordinate mode while setting the entire screen as the movement range of the cursor 4.

By contrast, when the hit area 6 has been pressed (Yes at S106), the display control unit 13 displays the on-screen key 5 (Step S110). To be more specific, the switch unit 12 switches the operation mode of the display control unit 13 to the absolute coordinate mode based on the contact information indicating that the hit area 6 is pressed. Subsequently, the display control unit 13 displays the on-screen key 5 in accordance with switching of the operation mode by the switch unit 12.

Then, the display control unit 13 performs movement control of the cursor 4 on the on-screen key 5 by the absolute coordinate operation (Step S112). To be more specific, the display control unit 13 starts the operation in the absolute coordinate mode, and displays the cursor 4 at a position, on the on-screen key 5, corresponding to touch coordinates on the touch pad 3.

By contrast, when the on-screen key 5 is displayed (Yes at S104), the display control unit 13 determines whether a close button on the on-screen key 5 has been pressed by the cursor 4 (Step S114).

When the close button has been pressed (Yes at S114), the display control unit 13 finishes display of the on-screen key 5 (Step S116). Here, the display control unit 13 also finishes display of the cursor 4.

By contrast, when the close button has not been pressed (No at S114), the switch unit 12 determines whether touch release has been performed after display of the on-screen key 5 (Step S118). To be more specific, the switch unit 12 determines whether the acquisition unit 11 has acquired contact information indicating that a finger is released from the touch pad 3 after acquiring contact information indicating that the hit area 6 is pressed.

When the touch release has not been performed (No at S118), the display control unit 13 performs movement control of the cursor 4 on the on-screen key 5 by the absolute coordinate operation (Step S120). To be more specific, the display control unit 13 continues the operation in the absolute coordinate mode started at Step S112 described above, and displays the cursor 4 at a position, on the on-screen key 5, corresponding to touch coordinates on the touch pad 3. Thus, the user can perform an intuitive operation with the texture of the edge portion around the touch pad 3 as a clue.

By contrast, when the touch release has been performed (Yes at S118), the display control unit 13 performs movement control of the cursor 4 on the on-screen key 5 by the relative coordinate operation (Step S122). To be more specific, the switch unit 12 switches the operation mode of the display control unit 13 to the relative coordinate mode based on the contact information indicating that the finger is released from the touch pad 3. The display control unit 13 performs the operation in the relative coordinate mode while limiting the movement range of the cursor 4 within a range of the on-screen key 5. In this manner, the user can perform the operation with the sense of the relative coordinate operation with which he/she is familiar in the operation of a notebook PC, for example.

The entire operation processing of the display control system of the embodiment has been described. The following will describe the processing of the switch unit 12 of switching the operation mode based on timing at which a finger is released from the touch pad 3, with reference to FIG. 11.

(Switching Processing 1)

FIG. 11 is a flowchart illustrating switching processing by the switch unit 12 according to the first embodiment. As illustrated in FIG. 11, the switch unit 12 sets the operation mode of the display control unit 13 to the absolute coordinate mode and starts an operation in the absolute coordinate mode (Step S202). Here, the display control unit 13 displays the on-screen key 5, and displays the cursor 4 at a position, on the on-screen key 5, corresponding to touch coordinates on the touch pad 3.

Next, the switch unit 12 determines whether a given period of time (first time) has elapsed from the start of the operation in the absolute coordinate mode (Step S204).

When the given period of time has not elapsed (No at S204), the switch unit 12 determines whether touch release has been performed (Step S206). When the touch release has not been performed (No at S206), the processing returns to Step S204 again. By contrast, when the touch release has been performed (Yes at S206), the switch unit 12 continues the operation of the display control unit 13 in the absolute coordinate mode (Step S208). Thus, even when the user releases his/her finger by mistake immediately after a pressing operation, the user can perform the absolute coordinate operation by touching the touch pad 3 again.

By contrast, when the given period of time has elapsed (Yes at S204), the switch unit 12 determines whether touch release has been performed (Step S210). When the touch release has not been performed (No at S210), the switch unit 12 continues the operation of the display control unit 13 in the absolute coordinate mode (Step S212). By contrast, when the touch release has been performed (Yes at S210), the switch unit 12 switches the operation mode of the display control unit 13 to the relative coordinate mode (Step S214). Thus, the user can perform an operation of roughly positioning the cursor 4 by the absolute coordinate operation and then finely adjusting the cursor 4 onto a small object on the screen by the relative coordinate operation.

The above has described the processing of the switch unit 12 according to the embodiment of switching the operation mode based on timing at which a finger is released from the touch pad 3. The following will describe the processing of the switch unit 12 of switching the operation mode based on time during with a finger is separate from the touch pad 3, with reference to FIG. 12.

(Switching Processing 2)

FIG. 12 is a flowchart illustrating switching processing by the switch unit 12 according to the first embodiment. As illustrated in FIG. 12, the switch unit 12 first sets the operation mode of the display control unit 13 to the absolute coordinate mode and starts an operation in the absolute coordinate mode (Step S302). Here, the display control unit 13 displays the on-screen 5 and displays the cursor 4 at a position, on the on-screen key 5, corresponding to touch coordinates on the touch pad 3.

Next, the switch unit 12 determines whether touch release has been performed (Step S304). When the touch release has not been performed (No at S304), the processing returns to Step S304 again.

By contrast, when the touch release has been performed (Yes at S304), the switch unit 12 determines whether a given period of time (second time) has elapsed from the touch release (Step S306).

When the given period of time has not elapsed (No at S306), the switch unit 12 continues the operation of the display control unit 13 in the absolute coordinate mode (Step S308). Next, the switch unit 12 determines whether the touch pad 3 has been touched (Step S310). To be more specific, the switch unit 12 determines whether the acquisition unit 11 has acquired contact information indicating that a finger is in contact with the touch pad 3. When the touch pad 3 has been touched (Yes at S310), the processing returns to Step S304 again. Thus, even when the user releases his/her finger by mistake, the user can continue the absolute coordinate operation by touching the touch pad 3 again immediately. By contrast, when the touch pad 3 has not been touched (No at S310), the processing returns to Step S306 again.

Then, the given period of time has elapsed (Yes at S306), the switch unit 12 switches the operation mode of the display control unit 13 to the relative coordinate mode (Step S312). Thus, when the user intentionally keeps his/her finger separate from the touch pad 3, he/she can perform the subsequent operation by the relative coordinate operation.

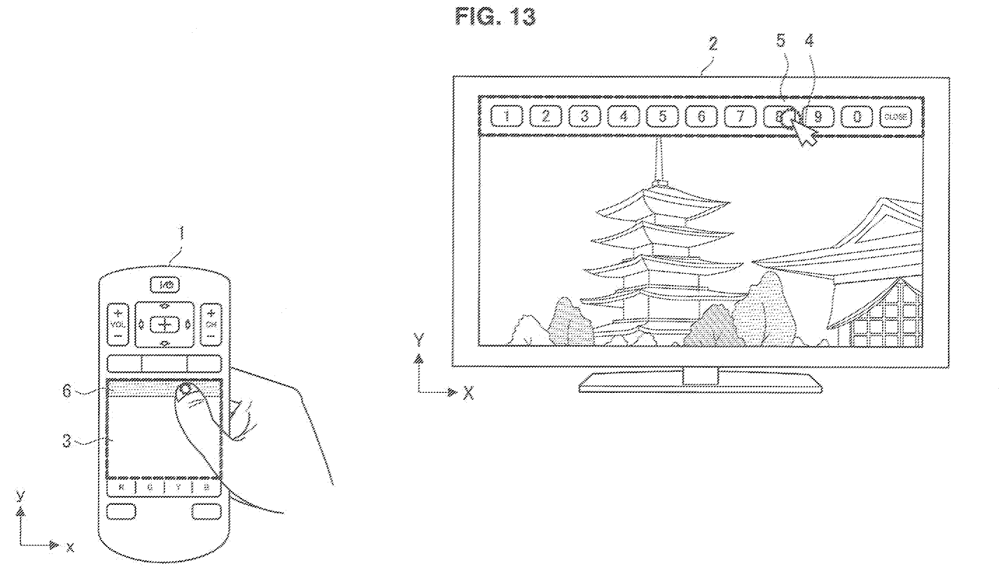

The operation processing of the display control system of the embodiment has been described. Subsequently, a modification of the embodiment will be described with reference to FIG. 13.

### [2-1-3. Modification]

FIG. 13 is a diagram for explaining a display control system according to a modification. As illustrated in FIG. 13, the operation terminal 1 of the modification includes the hit area 6 formed on area that is an end portion, in a y direction, of the touch pad 3 and extended between both ends in an x direction of the touch pad 3. When the hit area 6 has been touched, the operation terminal 1 of the modification displays the on-screen key 5 and the cursor 4 on the display device 2, and starts an operation in the absolute coordinate mode. Note that the operation terminal 1 of the modification does not display the on-screen key 5 or the cursor 4 even when an area other than the hit area 6 on the touch pad 3 has been touched and then the touch point has entered the hit area 6 by a user sliding his/her finger.

Here, as illustrated in FIG. 13, the on-screen key 5 is displayed on an area that is an end portion, in a Y direction, of the screen and extended between both ends in an X direction of the screen. Thus, the user can perform an intuitive operation with the texture of the edge portion around the end portion, in the y direction, of the touch pad 3, as a clue. Moreover, the operation terminal 1 of the modification may include, on the upper end, in the y direction, of the touch pad 3, an oblong convex texture served as a guide for a finger. The user can automatically move his/her finger in the x direction by moving the finger along the convex texture.

The operation terminal 1 of the modification may display the cursor 4 based on only an x direction component of touch coordinates. This is because the keys are arranged in a line in the X direction, as illustrated in FIG. 13 and thus the cursor 4 does not need to be moved in the Y direction, and fixing of the position, in the Y direction, of the cursor 4 reduces possibility of the case in which the cursor 4 is deviated from the keys. After the display of the on-screen key 5 and the cursor 4, the operation terminal 1 moves, when any portion of the touch pad 3 including the hit area 6 has been touched, the cursor 4 in accordance with a coordinate change of the x direction component of touch coordinates, and executes an operation command for determination and selection, for example, by a pressing operation or tapping.

When the hit area 6 has been touched, the operation terminal 1 of the modification may display the on-screen key 5 on the display device 2, and display the cursor 4 in the center of the on-screen key 5 or at the same position as the previous display to start the operation in the relative coordinate mode. Moreover, the operation terminal 1 of the modification may delete the display of the cursor 4 and the on-screen key 5 when two seconds, for example, have elapsed while a finger is separate from the touch pad 3, or continue the display to keep the operation in the relative operation mode when the touch pad 3 is touched again before two seconds have elapsed. The operation terminal 1 of the modification may delete display of the cursor 4 and the on-screen key 5 once a confirmation key (Return key) (not illustrated) is pressed.

Meanwhile, when the hit area 6 has been touched, the operation terminal 1 of the modification may operate constantly in the absolute coordinate mode. To be more specific, after the display of the on-screen key 5 and the cursor 4, the operation terminal 1 of the modification displays the cursor 4 at a corresponding position on the on-screen key 5 in accordance with coordinates of the x direction component of touch coordinates. In this case, the operation terminal 1 of the modification deletes display of the cursor 4 and the on-screen key 5 once a finger is released from the touch pad 3.

The forms of the hit area 6 and the on-screen key 5 are not limited to the forms illustrated in FIG. 3 and FIG. 13, and may be other forms. For example, the hit area 6 may be formed at the end portion in the x direction, and the on-screen key 5 may be formed at the end portion, in the X direction, of the screen.

The display control system of the modification has been described.

### 2-2. Second embodiment

### [2-2-1. Overview]

There have existed many products having a touch pad or a touch panel. However, the entire surface of the touch pad or the touch panel is a sensing area, and thus unintentional contact between the sensing area and a finger or a palm, for example, occurs, thereby causing a misoperation. With respect to such problems, there is developed the technology of detecting that a palm, for example, is in contact with the touch pad or the touch panel by analyzing electrical signals, for example. However, in the existing technology, even when a misoperation is detected, it is only removed automatically, and a user is not informed of the situation. Thus, a misoperation and another misoperation based on the misoperation are occurred continuously.

Then, in the embodiment, the user is warned when a misoperation of the user is detected, which prevents a misoperation, and thus further improves operability.

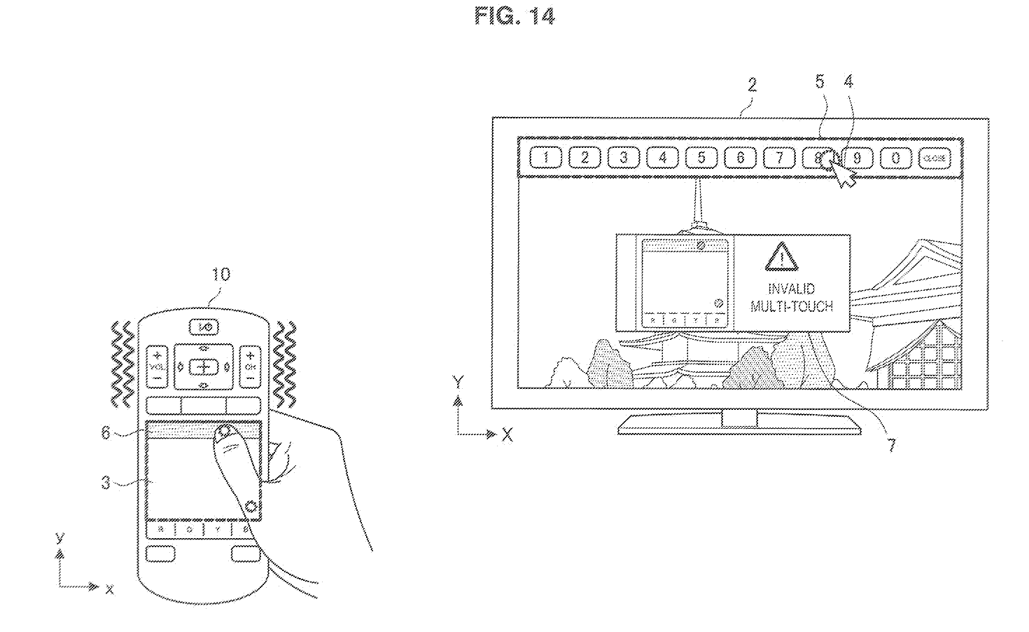

The embodiment can further improve operability by preventing an erroneous operation due to multi touch (multi-point touch). Here, the erroneous operation indicates an operation different from one intended by a user. An operation terminal 10 of the embodiment detects multi-touch causing an erroneous operation and performs erroneous operation prevention processing such as processing of stopping reception of inputs, correcting inputs and using them, or displaying warning to a user, for example. The multi-touch causing an erroneous operation includes unintentional touch due to a misoperation of a user, multi-touch having excessive touch points, or multi-point touch causing a ghost phenomenon, for example. In the following, the overview of the display control system according to the embodiment will be described with reference to FIG. 14.

FIG. 14 is an explanatory diagram illustrating the overview of a display control system according to a second embodiment. As illustrated in FIG. 14, the operation terminal 10 of the embodiment includes the hit area 6 formed on an area that is an end portion, in the y direction, of the touch pad 3 and extended between both ends, in the x direction, of the touch pad 3, similar to the modification of the first embodiment described above. The on-screen key 5 is displayed on an area that is an end portion, in the Y direction, of the screen and extended between both ends, in the X direction, of the screen.

When multi-touch has been received, the operation terminal 10 of the embodiment determines whether the multi-touch causes an erroneous operation. When the operation terminal 10 determines that the multi-touch causes an erroneous operation, it performs erroneous operation prevention processing. The erroneous operation prevention processing includes display of a warning image 7 (warning display) to a user, as illustrated in FIG. 14, and output of vibration or warning sound, for example. In addition, the operation terminal 10 may determine multi-touch causing an erroneous operation when the user performs unreserved contact in which his/her finger pad is brought into close contact with the touch pad 3, and display a warning image warning that the unreserved contact does not allow accurate acquisition of touch points. This is because, with such unreserved contact, two or more touch points may be acquired by mistake. By contrast, when the operation terminal 10 determines that the multi-touch does not cause an erroneous operation, it performs display control of the screen without performing erroneous operation prevention processing.

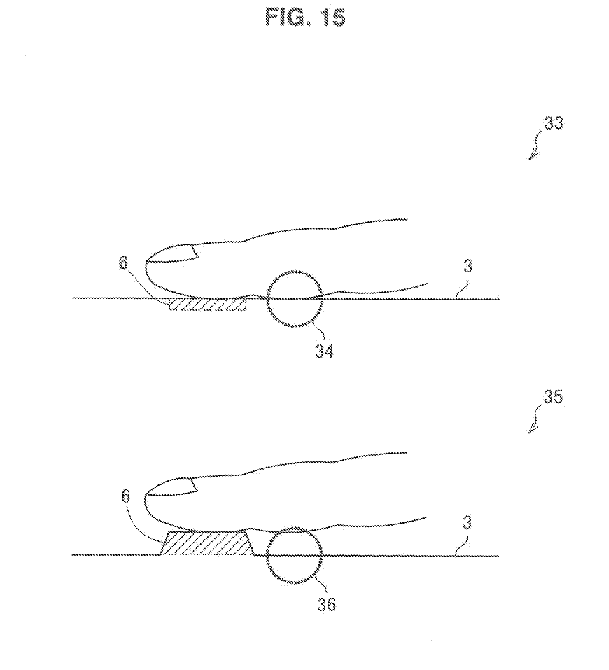

Moreover, the operation terminal 10 of the embodiment includes the touch pad 3 having a form with which multi-touch not intended by a user is difficult to occur, thus preliminarily preventing a misoperation of a user. The form will be described in the following with reference to FIG. 15.

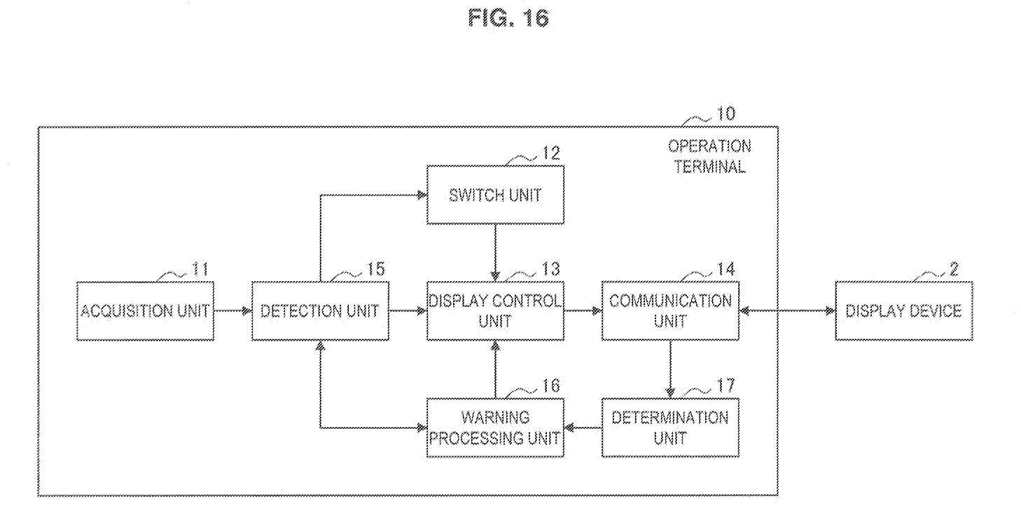

The overview of the display control system of the embodiment has been described. Next, the configuration of the display control system according to the embodiment will be described with reference to FIG. 15 to FIG. 16.

### [2-2-2. Configuration]

FIG. 15 is a side view illustrating an appearance configuration of the touch pad 3 according to the second embodiment. In the case of the flat touch pad 3, as illustrated in the configuration example 33 of FIG. 15, when the finger enters in the state near to horizontal to touch the hit area 6, for example, a part other than a fingertip may be unintentionally brought into contact with other areas (as illustrated by the reference numeral 34 in FIG. 15). In order to prevent this, the hit area 6 is formed to project above other areas of the touch pad 3 in the embodiment. When the hit area 6 projects above other areas, as illustrated in the configuration example 35 of FIG. 15, it is possible, even when the finger enters in the state near to horizontal, to prevent a part other than the fingertip from unintentionally being brought into contact with other areas because of a height difference (as illustrated by the reference numeral 36 in FIG. 15).

In addition to the arrangement of a height difference, the upper surface of the hit area 6 may be recessed. The touch coordinates in an operation becomes stable with a recess as a center, which reduces a position deviation in the operation and thus prevents a misoperation due to unintentional contact with other areas. Furthermore, a sensing area of the hit area 6 detecting contact of a finger may be optimized in accordance with a height difference or a form of a recess. To be more specific, with the assumption that touch coordinates are concentrated in a recess position when the hit area 6 is touched, the sensing area is reduced to only the area surrounding the recess. In this manner, it is possible to prevent an erroneous operation on other adjacent areas.

As described above, the display device 2 of the embodiment can correct a user operation by arranging a height difference or a recess, or optimizing a sensing area. Thus, an erroneous operation is preliminarily prevented without special attention of a user.

The appearance configuration of the touch pad 3 of the operation terminal 10 has been described. Next, the internal configuration of the operation terminal 10 will be described with reference to FIG. 16.

FIG. 16 is a block diagram illustrating an internal configuration of the operation terminal 10 according to the second embodiment. As illustrated in FIG. 16, the operation terminal 10 includes a detection unit 15, a warning processing unit 16, and a determination unit 17, in addition to the elements of the operation terminal 1 of the first embodiment 1. The same elements as in the operation terminal 1 of the first embodiment are as described above. Thus, the detailed explanation is omitted here.

(Detection Unit 15)

The detection unit 15 has a function of detecting multi-touch causing an erroneous operation based on a form of a contact area of the touch pad 3 and a finger, which is indicated by contact information acquired by the acquisition unit 11. To be more specific, the detection unit 15 detects multi-touch causing an erroneous operation based on the number of touch points, an area of each touch point, the positional relation between a touch point position and an operable area such as a button, or the positional relation between a plurality of touch points, for example.

For example, when the hit area 6 is touched with a fingertip of a thumb, as illustrated in FIG. 14, the root of the thumb may be brought into contact with an end portion of the touch pad 3 opposite to the hit area 6. The detection unit 15 recognizes that the multi-touch having touch coordinates separate from each other largely, as in this case, is due to a misoperation, and detects that the multi-touch causes an erroneous operation. Here, the detection unit 15 may assume, based on the fact that the touch points are positioned on the hit area 6 and on the lower right side of the touch pad 3, that the operation is performed by the right hand and the root of the thumb is unintentionally in contact. The same is applied also in the case of the left hand. In addition, when the number of contact positions is excessive, the detection unit 15 recognizes that the multi-touch is due to a misoperation, and detects that the multi-touch causes an erroneous operation. The concrete scene includes the case in which three or more touch points are detected when gesture inputs with two fingers at most are supported.

When a user performs unreserved contact on the touch pad 3, the detection unit 15 detects multi-touch causing an erroneous operation. To be more specific, the detection unit 15 determines whether unreserved contact has been performed based on an area of the touch point (a contact area) or contact strength and detects multi-touch causing an erroneous operation.

Moreover, the detection unit 15 detects multi-touch causing a ghost phenomenon as multi-touch causing an erroneous operation. The detection unit 15 detects that a ghost phenomenon is occurred based on a distance between a plurality of touch points, a time interval with which the touch points appear. Note that in order to distinguish touch coordinates touched actually from touch coordinates due to a ghost phenomenon, the latter touch coordinates are also referred to as ghost coordinates in the following.

When multi-touch causing an erroneous operation has not been detected, the detection unit 15 outputs contact information output from the acquisition unit 11 to the switch unit 12 and the display control unit 13. By contrast, when multi-touch causing an erroneous operation has been detected, the detection unit 15 performs processing of preventing an erroneous operation.

For example, when the detection unit 15 has detected multi-touch causing an erroneous operation, it stops output of contact information based on the control of the warning processing unit 16. This stops switching of operation modes, movement of the cursor 4, and reception of operation commands for confirmation or selection, for example, and thus prevents an erroneous operation.

Moreover, when the detection unit 15 has detected multi-touch causing an erroneous operation, it ignores touch coordinates not intended by a user or ghost coordinates, and outputs only contract information of touch points considered to be true inputs of the user to the switch unit 12 and the display control unit 13. In this manner, the user input is corrected, which enables the switch unit 12 and the display control unit 13 to switch operation modes or perform movement control of the cursor 4, for example, based on the true inputs of the user.

There can be considered various methods in which the detection unit 15 distinguishes true touch points by the user from unintentional touch points or ghost coordinates. For example, when it is clear, based on comparison of areas of touch points, that an area is excessively large or small assuming an operation with a finger, the detection unit 15 may determine that the touch point is unintentional or of ghost coordinates and adopt the other touch points as true touch points by the user. Alternatively, when the acquisition unit 11 can acquire pressure of contact points as contact information, the detection unit 15 may adopt the contact point higher in pressure as true touch point by the user.

When it is difficult to detect true touch points by the user or when the determination accuracy is low, the detection unit 15 outputs information indicating that the occurrence of an erroneous operation is highly possible to the warning processing unit 16.

(Determination Unit 17)

The determination unit 17 has a function of determining whether multi touch is allowed. To be more specific, the determination unit 17 performs communication with the display device 2 through the communication unit 14 and determines whether a screen displayed on the display device 2 allows multi-touch. For example, when the screen can accept an enlargement operation by an action of spreading two fingers while keeping them touched on the screen or a reduction operation by an action of bringing two fingers closer while keeping them touched on the screen, the determination unit 17 determines that the screen allows multi-touch. By contrast, when the screen can accept only a cursor movement operation with one finger, the determination unit 17 determines that the screen does not allow multi-touch.

In addition, the determination unit 17 determines whether a screen displayed on the display device 2 is a screen that requires cursor movement. For example, the determination unit 17 determines whether the screen requires cursor movement based on whether the cursor 4 is displayed on the screen.

The determination unit 17 outputs information indicating a determination result to the warning processing unit 16.

(Warning Processing Unit 16)

The warning processing unit 16 has a function of performing warning processing when the detection unit 15 detects multi-touch causing an erroneous operation and the determination unit 17 determines that multi-touch is not allowed. To be more specific, the warning processing unit 16 performs warning processing when the detection unit 15 outputs information indicating that the occurrence of an erroneous operation is highly possible and the determination unit 17 outputs a determination result indicating that multi-touch is not allowed.

As warning processing, the warning processing unit 16 controls the display control unit 13 to perform warning display on the display device 2. To be more specific, when a part of a palm, in addition to a finger, is in contact with the touch pad 3, the warning processing unit 16 displays a warning image indicating that the palm is in contact or a warning image recommending an operation method preventing contact of the palm such as an operation with one hand while supporting the touch pad 3 with the other hand. In addition, when touch points of the number exceeding the upper limit of the number that can be processed are detected, the warning processing unit 16 displays a warning image indicating that the number of touch points is excessive or a warning image indicating a recommended operation method.

Such warning display allows a user to clearly recognize the reason why an operation is not performed normally and an operation different from the intension is performed, when this happens. Thus, the user can immediately understand the prevention method or re-input method and perform an operation without any stress. Moreover, the user can learn, from a daily use, what kind of operation may cause problems easily. In this manner, the user can automatically learn, with the continuous use, the operation system with which an unintentional operation is difficult to occur.

The warning processing unit 16 controls a vibration unit and a speaker (not illustrated) to vibrate the operation terminal 10 as illustrated in FIG. 14 and output warning sound. In addition, the warning processing unit 16 controls the detection unit 15 to stop output of contact information to the switch unit 12 and the display control unit 13. Thus, the display control unit 13 stops display control such as cursor movement and a determination operation based on a user input.

It is supposed that the warning processing unit 16 performs at least one of such warning processing.

Meanwhile, even when the detection unit 15 detects multi-touch causing an erroneous operation, the warning processing unit 16 does not perform warning processing if the determination unit 17 determines that multi-touch is allowed. For example, it is assumed that a user performs an enlargement operation by an action of spreading two fingers while keeping them touched on a screen allowing multi-touch. Here, even when the ghost phenomenon is occurred and true touch coordinates by the user are not distinguished from ghost coordinates, it is possible to recognize that the touch coordinates become separate from each other. In such a case, the operation terminal 10 can perform image display in accordance with user's intention by enlarging the screen based on the fact that the touch coordinates become separate from each another. In this manner, the warning processing unit 16 can avoid excessive warning processing by switching on/off of warning processing in accordance with the state of the screen, and prevent increase of operation stress of the user.

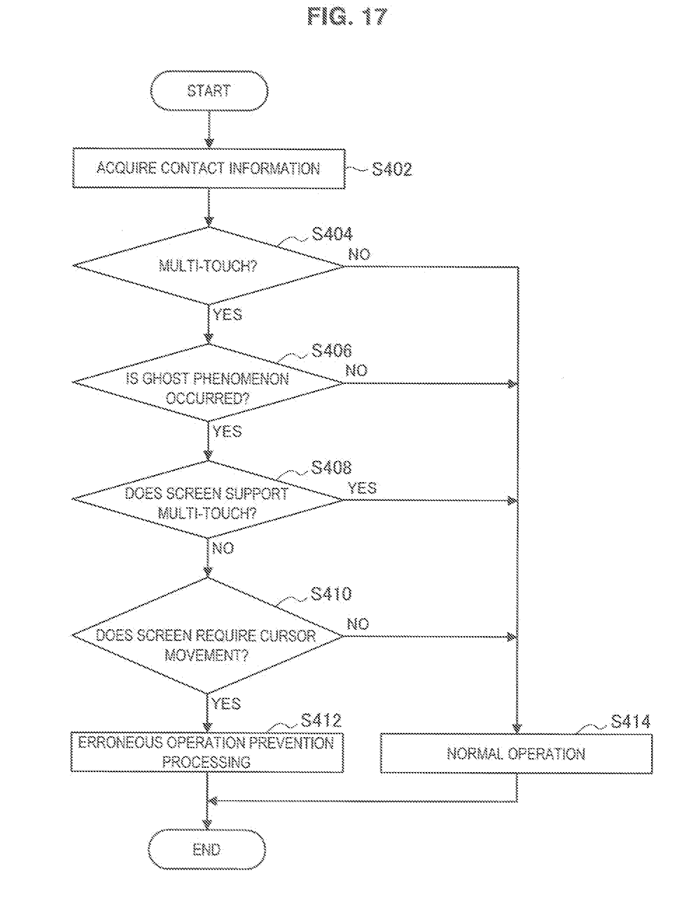

The configuration of the display control system according to the embodiment has been described. Subsequently, the operation processing of the display control system according to the embodiment will be described with reference to FIG. 17.

### [2-2-3. Operation Processing]

FIG. 17 is a flowchart illustrating operations of the display control system according to the second embodiment. Note that in FIG. 7, the operation processing when warning processing for multi-touch causing a ghost phenomenon is performed is described.

As illustrated in FIG. 17, the acquisition unit 11 first acquires contact information of contact of a finger on the touch pad 3 (Step S402). To be more specific, the acquisition unit 11 acquires, from the touch pad 3, information indicating coordinates of a touch point, or information indicating contact time or an operation kind such as touching and tapping. The acquisition unit 11 also acquires, from the switch 31, information indicating the presence or absence of a pressing operation.

Next, the detection unit 15 determines whether the contact is of multi-touch (Step S404). To be more specific, the detection unit 15 determines whether there exist a plurality of touch points based on contact information acquired by the acquisition unit 11.

When it is determined that the contact is not of multi-touch (No at S404), the operation terminal 10 performs a normal operation (Step S414). This is because when the contact is not of multi-touch, the ghost phenomenon does not occur and thus erroneous operation prevention processing is not necessary.

At Step S414, the detection unit 15 first outputs contract information output from the acquisition unit 11, as it is, to the switch unit 12 and the display control unit 13. Then, the switch unit 12 switches operation modes based on the contact information, and the display control unit 13 performs display control of the display device 2 by moving the cursor 4 and executing operation commands for confirmation or selection, for example, and

By contrast, when it is determined that the contact is of multi-touch (Yes at S404), the detection unit 15 determines whether the ghost phenomenon is occurred (Step S406). To be more specific, the detection unit 15 determines whether the ghost phenomenon is occurred based on a distance between a plurality of touch points, or a time interval with which the touch points appear, for example.

When it is determined that the ghost phenomenon is not occurred (No at S406), the operation terminal 10 performs a normal operation (Step S414). It is because the ghost phenomenon is not occurred and thus an erroneous operation due to the ghost phenomenon does not occur, which makes erroneous operation prevention processing unnecessary.

By contrast, when it is determined that the ghost phenomenon is occurred (Yes at S406), the determination unit 17 determines whether the screen supports multi-touch (Step S408). To be more specific, the determination unit 17 performs communication with the display device 2 through the communication unit 14 and determines whether a screen displayed on the display device 2 allows multi-touch.

When it is determined that the screen supports multi-touch (Yes at S408), the operation terminal 10 performs a normal operation (Step S414). To be more specific, the display control unit 13 controls display of the display device 2 by executing commands for screen enlargement or reduction by multi-touch, for example.

By contrast, when it is determined that the screen does not support multi-touch (No at S408), the determination unit 17 determines whether the screen requires cursor movement (Step S410). To be more specific, the determination unit 17 performs communication with the display device 2 through the communication unit 14 and determines whether the cursor 4 is displayed on a screen displayed on the display device 2.

When it is determined that the screen does not require cursor movement (No at S410), the operation terminal 10 performs a normal operation (Step S414). It is because the cursor 4 is not moved and the possibility of screen display against user's intension is low. For example, the display control unit 13 executes a command for menu activation, for example.

By contrast, when it is determined that the screen requires cursor movement (Yes at S410), the warning processing unit 16 performs erroneous operation prevention processing (Step S412). For example, the warning processing unit 16 controls the display control unit 13 to display a warning image on the display device 2, performs control so as to vibrate the operation terminal 10 or output warning sound, or stops display control by the display control unit 13.

The operation processing of the display control system of the embodiment has been described.

### 3. CONCLUSION

As described above, the operation terminal 1 of the first embodiment can further improve operability by effectively combining the relative coordinate operation and the absolute coordinate operation. To be more specific, the operation terminal 1 employs pressing and touch release of the hit area 6 to switch operation modes, thus providing a user with an intuitive operation by the absolute coordinate operation and a familiar operation by the relative coordinate operation.

Moreover, the operation terminal 10 of the second embodiment can further improve operability by preventing an erroneous operation due to multi-touch. To be more specific, the operation terminal 10 prevents an erroneous operation by performing warning display when multi-touch causing an erroneous operation is detected. Here, the operation terminal 10 presents the reason or a recommended operation method to a user for stress-free operation, and enables the user to learn the operation system with which an erroneous operation is difficult to occur. Moreover, the operation terminal 10 can also preliminarily prevent an erroneous operation by arranging a height difference or a recess on the touch pad 3 or optimizing a sensing area.

The preferred embodiments of the present disclosure have been described in detail with reference to the appended drawings. However, the technical scope of the present disclosure is not limited to such examples. It is clear that those skilled in the art can make various modification examples and correction examples within the technical scope of the appended claims, and it should be understood that they are also naturally within the technical scope of the present disclosure.

For example, it is possible to form, on hardware embedded in an information processing device, such as a central processing unit (CPU), a read only memory (ROM), and a random access memory (RAM), for example, a computer program for exerting the same functions as the elements of the above-described operation terminal 1 or operation terminal 10. Moreover, a recording medium recording such a computer program is also provided.

Additionally, the present technology may also be configured as below.

(1) A display control device including:

an acquisition unit configured to acquire contact information of contact of an operation body on an operation surface;

a display control unit that has a first function of moving a cursor displayed on a display device in accordance with a change amount of a contact position indicated by the contact information acquired by the acquisition unit and a second function of displaying the cursor at a position, on a given display area of the display device, corresponding to the contact position; and

a switch unit configured to switch a function to be exerted by the display control unit between the first function and the second function,

wherein the switch unit exerts the second function when the acquisition unit has acquired first contact information of contact of the operation body on a given operation area of the operation surface.

(2) The display control device according to (1), wherein the switch unit exerts the first function when the acquisition unit has acquired second contact information indicating that the operation body is released from the operation surface after exertion of the second function.
(3) The display control device according to (2), wherein the switch unit determines, based on whether first time has elapsed since exertion of the second function, whether the first function is to be exerted when the acquisition unit acquires the second contact information.
(4) The display control device according to (3), wherein the switch unit exerts the first function when the acquisition unit has acquired the second contact information after the first time has elapsed since exertion of the second function.
(5) The display control device according to (3) or (4), wherein the switch unit continues to exert the second function when the acquisition unit has acquired the second contact information before the first time has elapsed since exertion of the second function.
(6) The display control device according to any one of (2) to (5), wherein the second contact information is information indicating that the operation body is separate from the operation surface for second time.
(7) The display control device according to any one of (2) to (6), wherein the display control unit exerts the first function with the given display area as a movement range of the cursor when the acquisition unit has acquired, after exertion of the second function, the second contact information and the switch unit has switched the function to be exerted to the first function.
(8) The display control device according to any one of (2) to (7), wherein a movement amount of the cursor in accordance with the change amount of the contact position substantially matches between the first function to which the switch unit has switched the function to be exerted after acquisition of the second contact information by the acquisition unit and the second function.
(9) The display control device according to any one of (1) to (8), wherein the display control unit displays, on the display device, an image indicating the given display area when the switch unit has switched the function to be exerted to the second function.
(10) The display control device according to any one of (1) to (9), wherein the first contact information is at least one of pressing, touching, and tapping.
(11) The display control device according to any one of (1) to (10), further including a communication unit,

wherein the display control unit generates display control signals for controlling display of the display control device, and

wherein the communication unit transmits the display control signals generated by the display control unit to the display device.

(12) The display control device according to any one of (1) to (11), further including:

a detection unit configured to detect an input of multi-point causing an erroneous operation, based on a form of a contact area with the operation body that is indicated by the contact information acquired by the acquisition unit;

a determination unit configured to determine whether an input of multi-point is allowed; and

a warning processing unit configured to perform warning processing when the detection unit has detected an input of multi-point causing an erroneous operation and the determination unit has determined that the input of multi-point is not allowed.

(13) The display control device according to (12), wherein the given operation area is formed to project above other areas of the operation surface.
(14) The display control device according to (12) or (13), wherein the warning processing unit performs, as the warning processing, at least one of stop of display control by the display control unit, warning display on the display device, and output of vibration or warning sound.
(15) A display control method including:

acquiring contact information of contact of an operation body on an operation surface;

switching a function to be exerted between a first function of moving a cursor displayed on a display device in accordance with a change amount of a contact position indicated by the acquired contact information and a second function of displaying the cursor at a position, on a given display area of the display device, corresponding to the contact position: and

exerting the second function when first contact information of contact of the operation body on a given operation area of the operation surface has been acquired.

(16) A program causing a computer to execute:

acquiring contact information of contact of an operation body on an operation surface;

switching a function to be exerted between a first function of moving a cursor displayed on a display device in accordance with a change amount of a contact position indicated by the acquired contact information and a second function of displaying the cursor at a position, on a given display area of the display device, corresponding to the contact position; and

exerting the second function when first contact information of contact of the operation body on a given operation area of the operation surface has been acquired.

What is claimed is:

1. A display control device comprising:
an acquisition unit configured to acquire contact information of contact of an operation body on an operation surface;
a display control unit that has a first function of moving a cursor displayed on a display device in accordance with a change amount of a contact position indicated by the contact information acquired by the acquisition unit and a second function of displaying the cursor at a position, on a given display area of the display device, corresponding to the contact position; and
a switch unit configured to switch a function to be exerted by the display control unit between the first function and the second function,
wherein the switch unit exerts the second function when the acquisition unit has acquired first contact information of contact of the operation body on a given operation area of the operation surface.

2. The display control device according to claim 1, wherein the switch unit exerts the first function when the acquisition unit has acquired second contact information indicating that the operation body is released from the operation surface after exertion of the second function.

3. The display control device according to claim 2, wherein the switch unit determines, based on whether first time has elapsed since exertion of the second function, whether the first function is to be exerted when the acquisition unit acquires the second contact information.

4. The display control device according to claim 3, wherein the switch unit exerts the first function when the acquisition unit has acquired the second contact information after the first time has elapsed since exertion of the second function.

5. The display control device according to claim 3, wherein the switch unit continues to exert the second function when the acquisition unit has acquired the second contact information before the first time has elapsed since exertion of the second function.

6. The display control device according to claim 2, wherein the second contact information is information indicating that the operation body is separate from the operation surface for second time.

7. The display control device according to claim 2, wherein the display control unit exerts the first function with the given display area as a movement range of the cursor when the acquisition unit has acquired, after exertion of the second function, the second contact information and the switch unit has switched the function to be exerted to the first function.

8. The display control device according to claim 2, wherein a movement amount of the cursor in accordance with the change amount of the contact position substantially matches between the first function to which the switch unit has switched the function to be exerted after acquisition of the second contact information by the acquisition unit and the second function.

9. The display control device according to claim 1, wherein the display control unit displays, on the display device, an image indicating the given display area when the switch unit has switched the function to be exerted to the second function.

10. The display control device according to claim 1, wherein the first contact information is at least one of pressing, touching, and tapping.

11. The display control device according to claim 1, further comprising a communication unit,
wherein the display control unit generates display control signals for controlling display of the display control device, and
wherein the communication unit transmits the display control signals generated by the display control unit to the display device.

12. The display control device according to claim 1, further comprising:
a detection unit configured to detect an input of multi-point causing an erroneous operation, based on a form of a contact area with the operation body that is indicated by the contact information acquired by the acquisition unit;
a determination unit configured to determine whether an input of multi-point is allowed; and
a warning processing unit configured to perform warning processing when the detection unit has detected an input of multi-point causing an erroneous operation and the determination unit has determined that the input of multi-point is not allowed.

13. The display control device according to claim 12, wherein the given operation area is formed to project above other areas of the operation surface.

14. The display control device according to claim 12, wherein the warning processing unit performs, as the warning processing, at least one of stop of display control by the display control unit, warning display on the display device, and output of vibration or warning sound.

15. A display control method comprising:
acquiring contact information of contact of an operation body on an operation surface;
switching a function to be exerted between a first function of moving a cursor displayed on a display device in accordance with a change amount of a contact position indicated by the acquired contact information and a second function of displaying the cursor at a position, on a given display area of the display device, corresponding to the contact position; and
exerting the second function when first contact information of contact of the operation body on a given operation area of the operation surface has been acquired.

16. A program causing a computer to execute:
acquiring contact information of contact of an operation body on an operation surface;
switching a function to be exerted between a first function of moving a cursor displayed on a display device in accordance with a change amount of a contact position indicated by the acquired contact information and a second function of displaying the cursor at a position, on a given display area of the display device, corresponding to the contact position; and
exerting the second function when first contact information of contact of the operation body on a given operation area of the operation surface has been acquired.
